(19) United States
(12) Patent Application Publication
(10) Pub. No.: US 2023/0381965 A1
(43) Pub. Date: Nov. 30, 2023

(54) INFORMATION PROCESSING APPARATUS, INFORMATION PROCESSING METHOD, ROBOT SYSTEM, ARTICLE MANUFACTURING METHOD, AND RECORDING MEDIUM

(71) Applicant: CANON KABUSHIKI KAISHA, Tokyo (JP)

(72) Inventors: YUKO KAWAGUCHI, Kanagawa (JP); HIRONOBU SASAKI, Kanagawa (JP); SATOSHI SUGAYA, Kanagawa (JP)

(21) Appl. No.: 18/321,683

(22) Filed: May 22, 2023

(30) Foreign Application Priority Data
May 27, 2022 (JP) 2022-086971
Mar. 27, 2023 (JP) 2023-050403

(51) Int. Cl. B25J 9/16

(52) U.S. Cl. CPC B25J 9/1664; B25J 9/163

(57) ABSTRACT

An information processing apparatus includes one or more processors configured to cause the information processing apparatus to perform a simulation of operations of a robot in a virtual space, and output positional information about the operations of the robot that has performed the simulation together with animation data of the operations of the robot that has performed the simulation.

### BACKGROUND

### Field of the Disclosure

The present disclosure relates to information processing.

### Description of the Related Art

In recent years, the use of robot-based apparatuses has automated assembly, conveyance, and painting operations in industrial production lines. There has been research on simulation techniques for reviewing and validating relevant robot operations not in the real space but in a virtual space in advance. This research enables in a virtual space, for example, checking operation contents, operation time, motion path of a robot, and information (teaching point) used to teach the robot, and reviewing whether operations used to teach the robot interfere with surrounding objects. However, in a case of sharing simulation results on a simulator with another user in reviewing robot operations, the other user also needs to install the simulator. Thus, there has been a demand for a technique for easily sharing simulation results with other users. The following technique discussed in Japanese Patent Application Laid-Open No. 2016-13579 generates animation data for three-dimensionally displaying status changes along the time passage based on three-dimensional data of a robot and operation process data including robot operation contents, and outputs animation data in an electronic document format. This technique proposes a method of sharing simulation results with other users.

### SUMMARY

According to embodiments of the present disclosure, an information processing apparatus includes one or more processors configured to cause the information processing apparatus to perform a simulation of operations of a robot in a virtual space, and output positional information about the operations of the robot that has performed the simulation together with animation data of the operations of the robot that has performed the simulation.

Further features of the present disclosure will become apparent from the following description of exemplary embodiments with reference to the attached drawings.

### BRIEF DESCRIPTION OF THE DRAWINGS

FIG. 1 is a schematic view illustrating a robot system according to a first exemplary embodiment.

FIGS. 2A and 2B illustrate configurations of a robot arm and a robot hand, respectively, according to the first exemplary embodiment.

FIG. 3 illustrates a simulator according to the first exemplary embodiment.

FIG. 4 is a block diagram illustrating a computer system according to the first exemplary embodiment.

FIG. 5 illustrates an animation generation window according to the first exemplary embodiment.

FIG. 6 is a control flowchart illustrating animation output processing according to the first exemplary embodiment.

FIG. 7 is a control flowchart illustrating details of step S1 in animation output setting according to the first exemplary embodiment.

FIG. 8 illustrates operations in an animation output setting area at the time of execution of step S1-1 according to the first exemplary embodiment.

FIG. 9 illustrates operations in an animation output setting area at the time of execution of step S1-2 according to the first exemplary embodiment.

FIG. 10 illustrates operations in an animation output setting area at the time of execution of step S1-3 according to the first exemplary embodiment.

FIG. 11 is a control flowchart illustrating details of additional information setting (step S1′) to information set in step S1 in the animation output setting according to the first exemplary embodiment.

FIGS. 12A to 12C illustrate operations in an additional processing setting area at the time of execution of step S1′-1 according to the first exemplary embodiment.

FIGS. 13A to 13C illustrate operations in an additional processing setting area at the time of execution of step S1′-2 according to the first exemplary embodiment.

FIGS. 14A to 14C illustrate operations in an additional processing setting area at the time of execution of step S1′-3 according to the first exemplary embodiment.

FIGS. 15A and 15B illustrate operations in an additional processing setting area at the time of execution of step S1′-4 according to the first exemplary embodiment.

FIG. 16 illustrates an animation generation window displayed when a preview button according to the first exemplary embodiment is pressed.

FIG. 17 illustrates an animation generation window according to a second exemplary embodiment.

FIG. 18 illustrates the animation generation window according to a third exemplary embodiment.

FIG. 19 illustrates the animation generation window according to a fourth exemplary embodiment.

FIG. 20 illustrates the animation generation window according to the fourth exemplary embodiment.

FIG. 21 is another schematic view illustrating the robot system according to a fifth exemplary embodiment.

FIG. 22 is another block diagram illustrating the computer system according to the fifth exemplary embodiment.

FIG. 23 illustrates an animation sharing screen according to the fifth exemplary embodiment.

FIG. 24 illustrates an animation sharing screen according to the fifth exemplary embodiment.

FIG. 25 illustrates an animation sharing screen according to the fifth exemplary embodiment.

FIGS. 26A and 26B illustrate examples of operation terminals according to the fifth exemplary embodiment.

FIG. 27 is a block diagram illustrating a computer system according to a sixth exemplary embodiment.

### DESCRIPTION OF THE EMBODIMENTS

However, the technique discussed in Japanese Patent Application Laid-Open No. 2016-13579 does not refer to displaying information about robot operations (information such as motion paths or teaching points) in output information about simulation results. It has thereby been difficult to easily grasp detailed information, such as the motion path to be traced by the robot and the position where the operations were taught to the robot.

Embodiments of the present disclosure are directed to enabling a user to easily grasp information about robot operations in output information about simulation results.

Exemplary embodiments of the present disclosure will be described below with reference to the accompanying drawings. The following exemplary embodiments are to be considered as illustrative. For example, detailed configurations can be suitably modified in diverse ways by those skilled in the art without departing from the spirit and scope of the present disclosure. Numeric values according to the present exemplary embodiment are to be considered as numeric values for reference, and do not limit the present disclosure. In the following drawings, arrows X, Y, and Z indicate the overall coordinate system of a robot system. Generally, an XYZ three-dimensional coordinate system represents the world coordinate system in the entire installation environment. Based on convenience for the robot control, a local coordinate system may be suitably used for robot hands, fingers, and joints. According to the present exemplary embodiments, the world coordinate system as the overall coordinate system is represented by XYZ while the local coordinate system is represented by xyz.

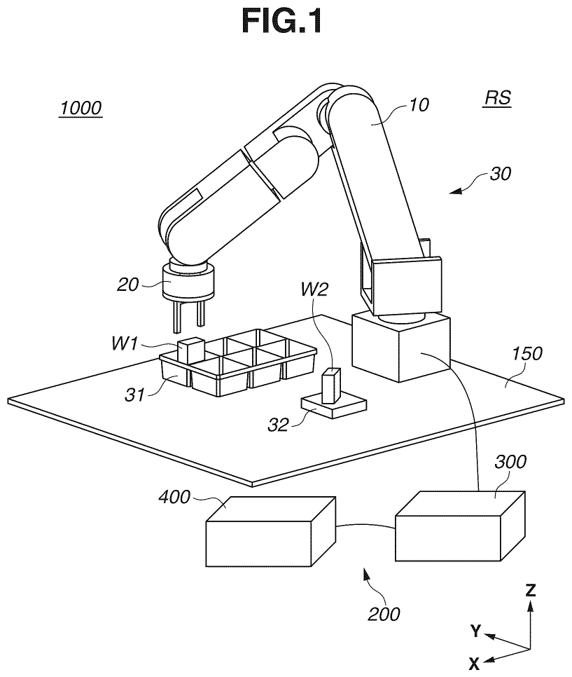

FIG. 1 illustrates an overall configuration of a robot system 1000 according to a first exemplary embodiment. FIG. 1 schematically illustrates the robot system 1000 in a real space RS. The robot system 1000 includes a robot body 30 and a computer system 200 as an example of a control apparatus. The computer system 200 includes a plurality of computers. In the present exemplary embodiment, the computer system 200 includes a robot controller 300 and a simulator 400 as an example of a simulation apparatus.

The robot body 30 is a manipulator which is fixed to a stand 150. Around the robot body 30, a tray 31 and a work W2 are arranged. The tray 31 holds a work W1 as an object to be carried. The work W2 is an assembly target on which the work W1 is to be assembled. The work W2 is arranged in the tray 32. The work W1 is gripped by the robot body 30 and conveyed to the position of the work W2.

The robot body 30 and the robot controller 300 are communicably connected with wiring. The robot controller 300 and the simulator 400 are communicably connected with wiring.

The robot body 30 is composed of a robot arm 10 and a robot hand 20 as an example of an end effector. The robot arm 10 is a vertical articulated robot arm. The robot hand 20 is supported by the robot arm 10. The robot hand 20 is attached to a predetermined portion of the robot arm 10, for example, the tip of the robot arm 10. The robot hand 20 is configured to grip the work W1.

The simulator 400 virtually performs and displays operations of the robot body 30 to grip the work W1 through offline teaching, i.e., computer simulation. The robot controller 300 acquires information about the grip position from the simulator 400, and generates motion path data of the robot body 30, ranging from the grip position to the position of the conveyance destination of the work W1. The robot controller 300 controls the robot body 30 based on the generated motion path data to perform operations for conveying the work W1. According to the present exemplary embodiment, the robot body 30 performs operations for conveying the gripped work W1 and then assembling the work W1 on the work W2. This enables manufacturing an industrial product or an article. The simulator 400 can perform the calculation of the motion path data.

When the robot body 30 conveys the work W1, the robot body 30 needs to be taught not to come into contact with objects around the robot body 30. Teaching the robot body 30 means setting teaching points for obtaining the motion path data of the robot body 30.

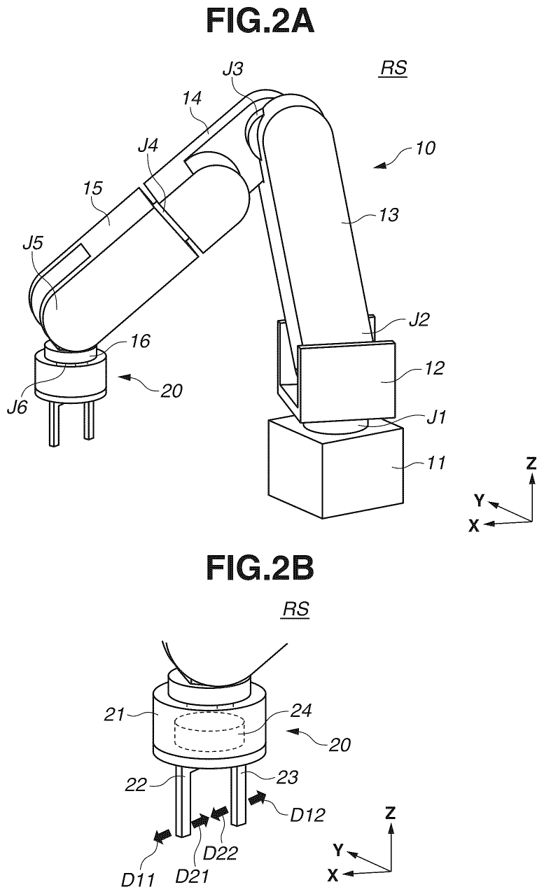

FIG. 2A illustrates a configuration of the robot arm 10 and the robot hand 20 according to the present exemplary embodiment. The robot arm 10 is composed of a plurality of links 11 to 16 connected with a plurality of rotatably driven joints J1 to J6. The rink 11 as a base of the robot arm 10 is fixed to the stand 150. Each joint of the robot arm 10 is provided with a motor as a drive source for driving the joint, a reduction gear, and an encoder as a position detection unit for detecting the rotational angle of the motor. The installation position and output method of the encoder are not limited to specific ones. The robot hand 20 is attached to the link 16 at the tip of the robot arm 10. Driving the joints J1 to J6 of the robot arm 10 enables setting the robot body 30 to various postures.

FIG. 2B illustrates the robot hand 20 according to the present exemplary embodiment. The robot hand 20 is composed of a palm 21 and a plurality of fingers, for example, two fingers 22 and 23, supported by the palm 21 to open and close. The two fingers 22 and 23 are disposed to face each other.

The robot hand 20 has a force control function for moving the fingers 22 and 23 with a constant force. The palm 21 of the robot hand 20 supports the fingers 22 and 23, and includes a drive unit 24 for linearly moving the pair of two fingers 22 and 23. The drive unit 24 includes a motor and a conversion mechanism for converting a rotary motion of the motor into a linear motion. By operating the drive unit 24, the fingers 22 and 23 can be moved in opening directions D11 and D12 and closing directions D21 and D22 as indicated by the arrows in FIG. 2B. The drive unit 24 generates a driving force to produce a gripping force of the fingers 22 and 23 to grip the work W1. The fingers 22 and 23 need to grip the work W1 so that the fingers 22 and 23 do not change the position of the work W1 relative to the robot arm 10. Although the present exemplary embodiment uses two fingers, the number of the fingers can be suitably changed by those skilled in the art. Although, in the present exemplary embodiment, the robot hand 20 operates the fingers by motor drive, the fingers 22 and 23 can be operated by a pneumatically driven air gripper.

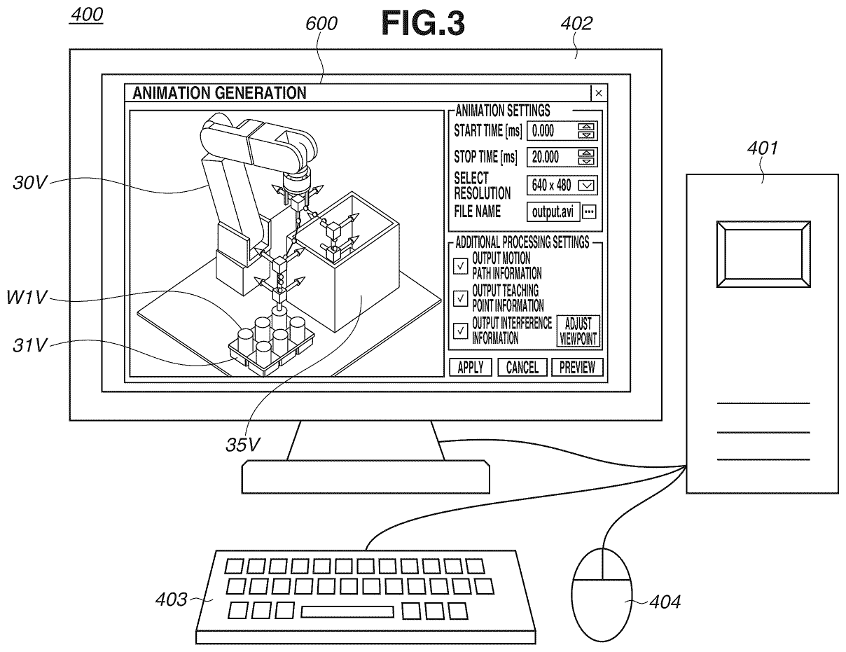

FIG. 3 illustrates the simulator 400 according to the present exemplary embodiment. The simulator 400 includes a simulator unit 401, a display 402 as an example of a display device connected to the simulator unit 401, and a keyboard 403 and a mouse 404 as examples of input devices connected to the simulator unit 401. The display 402 displays an animation generation window 600 when the simulator unit 401 executes an application software for implementing a simulation method as a teaching method. The animation generation window 600 displays a virtual space VS configured by the simulator unit 401. In the virtual space VS, a virtual robot body 30V, a virtual work W1V, a virtual tray 31V, a virtual wall 35V, and the like are arranged. These items are displayed as two-dimensional (2D) or three-dimensional (3D) images on the display 402. Although not illustrated in FIG. 1, referring to the state in FIG. 3, the simulator 400 simulates a case where a wall 35 is placed around the tray 32 and the work W2.

The virtual robot body 30V is a robot model corresponding to the robot body 30. The virtual work W1V is a work model corresponding to the work W1. The virtual tray 31V is a tray model corresponding to the tray 31. The virtual wall 35V is a wall model corresponding to the wall 35. Three-dimensional data for each model is registered in advance in the simulator unit 401 as, for example, computer aided design (CAD) data. After the operator operates the keyboard 403 and the mouse 404 to input data to the simulator unit 401, the operator can instruct the simulator unit 401 to simulate operations of the robot body 30 in the virtual space VS. Although the present exemplary embodiment uses a commonly used desktop personal computer (PC) as the simulator 400, the present disclosure is not limited thereto. For example, a terminal apparatus, such as a tablet PC, is also applicable, or a simulator function can alternatively be implemented on a teaching pendant.

The present exemplary embodiment teaches operations of the robot body 30 related to the work W1 by using the robot hand 20 of the robot body 30 through offline teaching. Determining operations of the robot body 30 means determining the rotation amounts of the joints J1 to J6. However, in a case where the robot hand 20 has joints, and the positions of the fingers 22 and 23 in the rotational direction can be changed, it is necessary to determine the amount of rotation of the joint of the robot hand 20. The fingers 22 and 23 of the robot hand 20 in an open state are moved in the closing direction D21 and D22 to come into contact with the work W1, and a gripping force is applied to the fingers 22 and 23, thereby enabling the fingers 22 and 23 to grip the work W1. The grip position refers to the position of the robot body 30 relative to the work W1 when the robot body 30 grips the work W1. In a state where the work W1 has been positioned relative to the robot body 30, the grip position corresponds to the posture of the robot body 30 when robot body 30 grips the work W1. In a state where the work W1 has been positioned relative to the robot body 30, setting the robot body 30 to a predetermined posture thus enables the robot body 30 to grip the work W1 at a predetermined grip position.

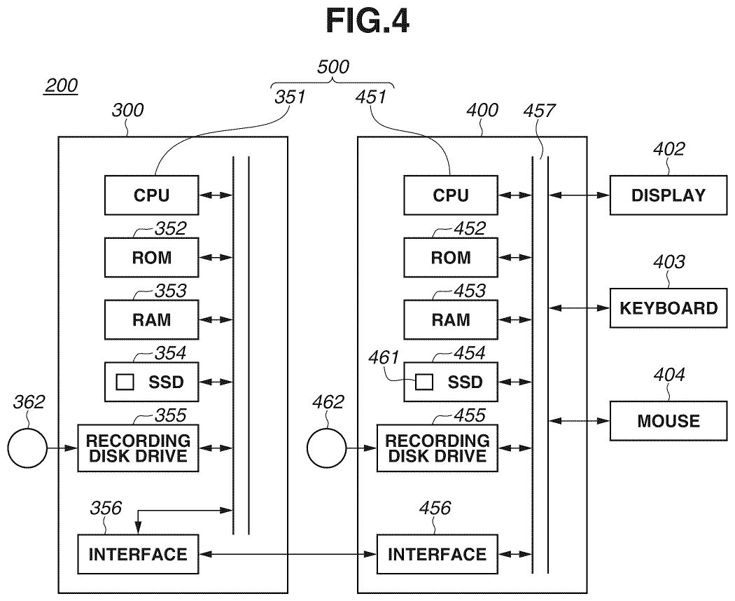

FIG. 4 is a block diagram illustrating the computer system 200 according to the present exemplary embodiment. The simulator unit 401 of the simulator 400 includes a central processing unit (CPU) 451 as an example of a processor. The CPU 451 is an example of a processing unit. The simulator unit 401 includes a read only memory (ROM) 452, a random access memory (RAM) 453, and a solid state drive (SSD) 454 as a storage unit. The simulator unit 401 also includes a recording disk drive 455 and an interface 456 that communicates with the robot controller 300. The CPU 451, the ROM 452, the RAM 453, the SSD 454, the recording disk drive 455, and the interface 456 are connected to a bus 457 so that they can communicate with each other. The display 402, the keyboard 403, and the mouse 404 are each connected to the bus 457 via an interface.

The ROM 452 stores basic programs related to computer operations. The RAM 453 is a storage device for temporarily storing various pieces of data, such as calculation processing results of the CPU 451. The SSD 454 records calculation processing results of the CPU 451 and various pieces of data acquired from the outside, and a program 461 for causing the CPU 451 to execute various pieces of processing. The program 461 is an application software that can be executed by the CPU 451.

The CPU 451 executes the program 461 recorded in the SSD 454 to perform simulation processing. This enables simulating operations of the robot body 30 by using the virtual robot in the virtual space to acquire data of the motion teaching point. The recording disk drive 455 can read various pieces of data and programs recorded in a recording disk 462. The recording disk drive 455 can read data recorded in the recording disk 462 as an example of a recording medium. The recording disk drive 455 can write model data or simulation result data to the recording disk 462 as animation data (animation file).

By the user inputting information via the keyboard 403 and the mouse 404, the CPU 451 generates animation data containing motion path information for models for each control period in the simulation, and stores the animation data in the ROM 452 or SSD 454. In addition to the motion path information, the animation data includes teaching point information as target values of joint positions for each axis of the robot body 30, and interference information between one or more models, which can be referenced in the simulation.

In the present exemplary embodiment, the program 461 is recorded in the SSD 454, which is a computer-readable non-transitory recording medium. However, the recording medium is not limited thereto. The program 461 can be recorded in any type of recording media as long as the media is a computer-readable non-transitory recording medium. Examples of the recording media for supplying the program 461 to the computer include a flexible disk, hard disk, optical disk, magneto-optical disk, magnetic tape, and nonvolatile memory.

The robot controller 300 includes a CPU 351 as an example of a processor. The robot controller 300 also includes a ROM 352, a RAM 353, and an SSD 354 as storage units. The robot controller 300 includes a recording disk drive 355 and an interface 356 for communicating with the simulator 400. The CPU 351, the ROM 352, the RAM 353, the SSD 354, the recording disk drive 355, and the interface 356 are connected to a bus 357 so that they can communicate with each other.

The ROM 352 stores basic programs related to computer operations. The RAM 353 is a storage device for temporarily storing various pieces of data, such as calculation processing results of the CPU 351. The SSD 354 records (stores) calculation processing results of the CPU 351 and various pieces of data acquired from the outside, and a program 361 for causing the CPU 351 to execute various pieces of processing. The program 361 is an application software that can be executed by the CPU 351.

The CPU 351 executes the program 361 recorded in the SSD 354 to perform control processing, making it possible to control operations of the robot body 30 illustrated in FIG. 1. The recording disk drive 355 can read various pieces of data and programs recorded in a recording disk 362.

In the present exemplary embodiment, the program 361 is recorded in the SSD 354, which is a computer-readable non-transitory recording medium. However, the recording medium is not limited thereto. The program 361 can be recorded in any type of recording medium as long as the recording medium is a computer-readable non-transitory recording medium. Examples of recording media for supplying the program 361 to the computer include a flexible disk, hard disk, optical disk, magneto-optical disk, magnetic tape, and nonvolatile memory.

In the present exemplary embodiment, a plurality of CPUs (CPUs 351 and 451) communicable with each other configures a control unit 500. In the present exemplary embodiment, the CPU 351 performs the control processing, and the CPU 451 performs the simulation processing. Although, in the present exemplary embodiment, the control processing and the simulation processing are performed by the plurality of computers (i.e., the CPUs 351 and 451), the present disclosure is not limited thereto. The control processing and the simulation processing can be performed by a single computer, i.e., a single CPU. In this case, one CPU can be configured to function as a control unit and a processing unit.

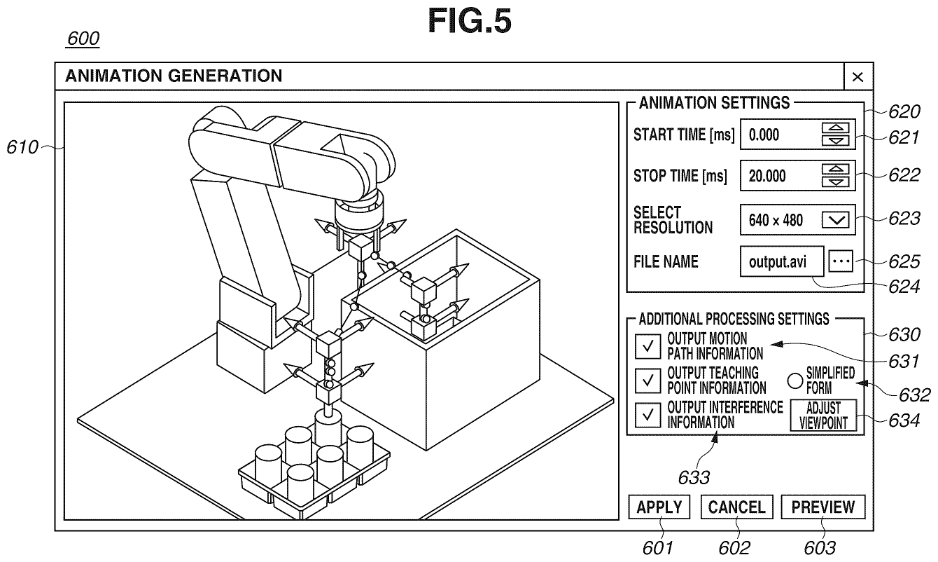

FIG. 5 illustrates in details the animation generation window 600 according to the present exemplary embodiment. The animation generation window 600 in FIG. 5 is a screen used to generate (acquire) an animation related to simulation results. The animation generation window 600 is called at the time of execution of the program stored in the ROM 452 and displayed on the display 402. The window 600 includes a simulation result display area 610, an animation output setting area 620, and an additional processing setting area 630. The window 600 also includes an apply button 601 for determining to output simulation results as an animation, a cancel button 602 for canceling outputting simulation results as an animation, and a preview button 603 for previewing an animation with various settings applied.

The virtual section displayed in the simulation result display area 610 can be changed with the mouse 404. Drag and click operations with the mouse 404 enable changing the viewpoint position. Scroll operations with the mouse wheel (not illustrated) of the mouse 404 enable enlarging or reducing the visual field.

Referring to FIG. 5, the animation output setting area 620 includes a start time setting area 621, a stop time setting area 622, a resolution setting area 623, a file name setting area 624, and an output destination selection button 625. The animation output setting area 620 to be described in detail below functions as a graphical user interface (GUI) for making various settings for animation information used in outputting simulation results as animation data. The animation data to be output in this case is an animation generated separately from the animation displayed in the simulation result display area 610. More specifically, the animation data to be output is displayed independently and separately from the one displayed in the virtual space by the simulator 400.

The additional processing setting area 630 includes a motion path information setting area 631, a teaching point information setting area 632, an interference information setting area 633, and a viewpoint adjust button 634. The motion path information setting area 631, the teaching point information setting area 632, and the interference information setting area 633 are supplied with check boxes. The additional processing setting area 630 functions as a GUI for setting information about operations of the robot body 30 in simulation results (positional information), and information about the viewpoint for viewing the simulation (details will be described below). The teaching point information setting area 632 also includes a check box for setting whether to display the motion teaching point in a simplified form.

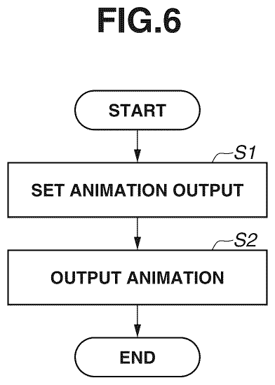

FIG. 6 illustrates a control flowchart illustrating animation output processing according to the present exemplary embodiment. As illustrated in FIG. 6, the CPU 451 sequentially performs processing for setting animation output in step S1 and outputting an animation in step S2. Step S1 will now be described.

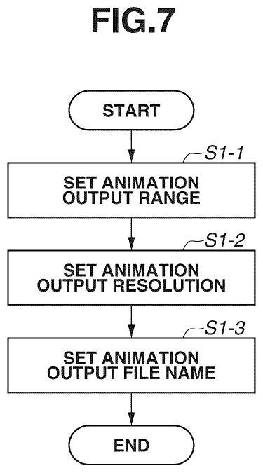

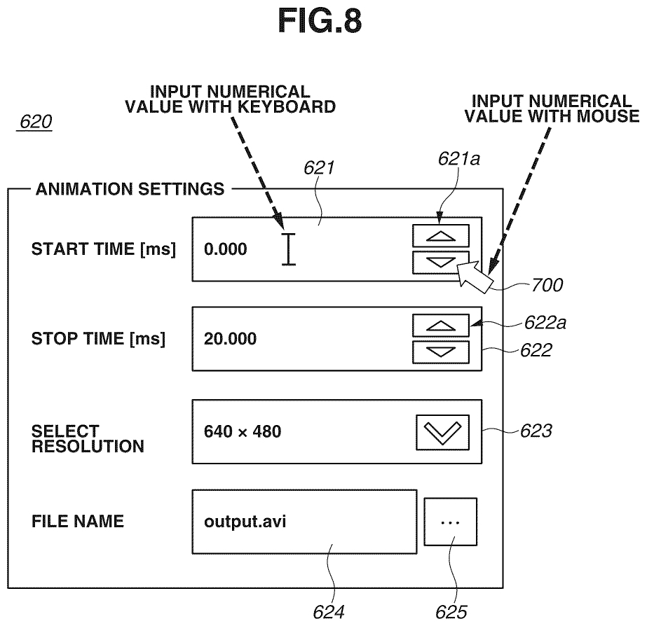

FIG. 7 is a control flowchart illustrating details of the animation output setting in step S1 according to the present exemplary embodiment. FIG. 8 illustrates operations in the animation output setting area 620 at the time of execution of step S1-1 according to the present exemplary embodiment. As illustrated in FIG. 7, in step S1, the CPU 451 sequentially performs processing for setting an animation output range in step S1-1, setting an animation output resolution in step S1-2, and setting an animation output file name in step S1-3.

Referring to FIGS. 7 and 8, in step S1-1, the CPU 451 sets an animation start time and an animation stop time as information about the animation output range when outputting simulation results as an animation. For the start time and the stop time, predetermined timing times in simulation results are set. To specify an animation output range, the user can input numerical values in the start time setting area 621 and the stop time setting area 622 with the mouse 404 or the keyboard 403. A cursor 700 can be operated with the mouse 404. When inputting numerical values with the keyboard 403, the user activates the start time setting area 621 or the stop time setting area 622 with the cursor 700 and then inputs a numerical value with the keyboard 403. The numerical values can also be set by clicking up-and-down arrow keys 621a in the start time setting area 621, and up-and-down arrow keys 622a in the stop time setting area 622 with the cursor 700. Although, in the present exemplary embodiment, clicking once the up-and-down arrow key 621a or 622a increments or decrements the value by one second. However, the present disclosure is not limited thereto. The number of seconds to be incremented or decremented for each click can be set appropriately.

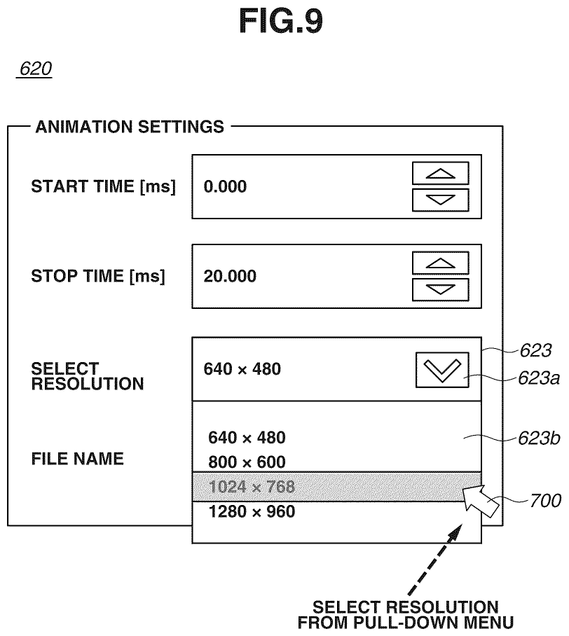

FIG. 9 illustrates operations in the animation output setting area 620 at the time of execution of step S1-2 according to the present exemplary embodiment. In step S1-2, the CPU 451 sets the resolution of a simulation image when outputting animation data. To specify a resolution setting, the user can select a resolution from a pull-down menu 623b in the resolution setting area 623, as illustrated in FIG. 9. When the user clicks a pull-down button 623a with the cursor 700, the pull-down menu 623b appears. When the user clicks on any one item from the pull-down menu 623b with the cursor 700, the selected resolution is set to the resolution setting area 623.

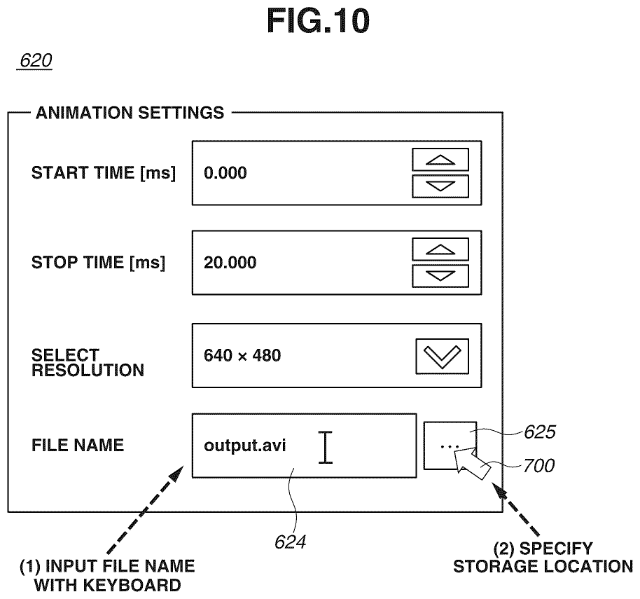

FIG. 10 illustrates operations in the animation output setting area 620 at the time of execution of step S1-3 according to the present exemplary embodiment. In step S1-3, the CPU 451 sets the output file name to be used when outputting simulation results as animation data. To specify an output file name, the user can input the file name in the file name setting area 624 with the keyboard 403. When the user specifies an output file name with the keyboard 403 and then clicks on the output destination selection button 625 with the cursor 700, the output destination of the animation data is specified. In this case, the format of the animation to be output can be optionally set depending on the status of the animation codec. Examples of animation formats include Audio Video Interleave (AVI®), Moving Picture Experts Group (MPEG)-4, and Flash Video (FLV). Other examples of animation formats include Windows® Media Video (WMV), WebM, and Advanced Video Coding High Definition (AVCHD®).

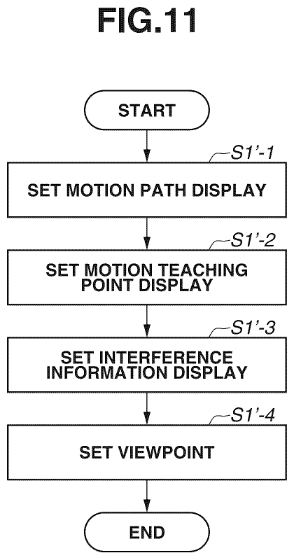

FIG. 11 illustrates a control flowchart illustrating details of additional information setting (step S1′) to the information set in the animation output setting (step S1) according to the present exemplary embodiment. Referring to FIG. 11, the CPU 451 sequentially performs processing for setting the motion path display in step S1′-1, setting an animation teaching point in step S1′-2, setting the interference information display in step S1′-3, and setting the visual field adjustment in step S1-3′. The processing in step S1′ is additional processing following the processing in step S1. The user can select whether to perform the processing in step S1′.

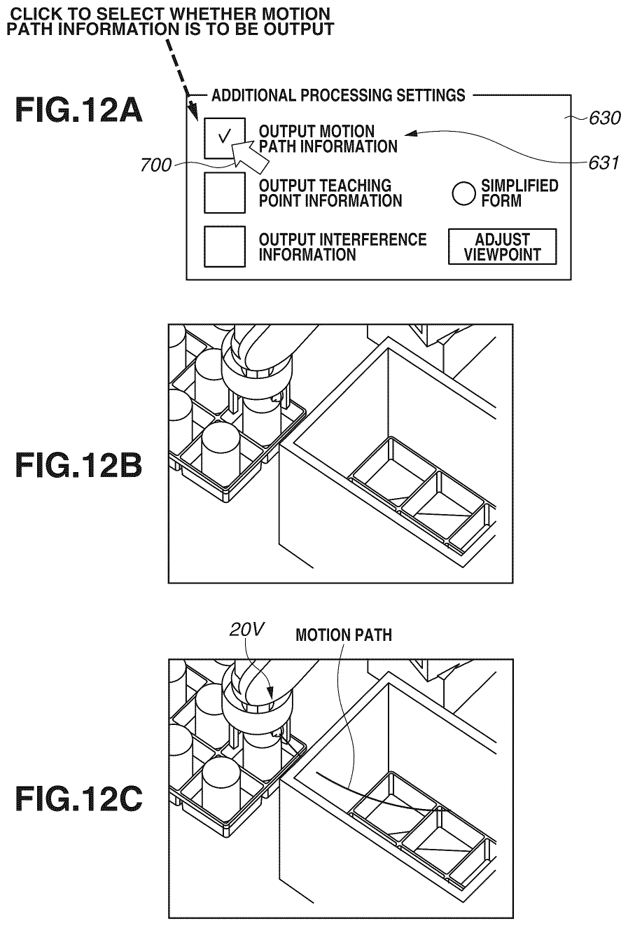

FIGS. 12A to 12C illustrate operations in the additional processing setting area 630 at the time of execution of step S1′-1 according to the present exemplary embodiment. In step S1′-1, the CPU 451 sets whether to output the motion path information in the animation when outputting simulation results as animation data. FIG. 12A illustrates the additional processing setting area 630 when information about the motion path of a virtual robot hand 20V of the virtual robot body 30V is displayed in the animation data to be output via the additional processing setting area 630. FIG. 12B illustrates an animation with the motion path undisplayed. FIG. 12C illustrates the animation with the motion path displayed.

Referring to FIG. 12A, the user clicks the check box of the motion path information setting area 631 with the cursor 700 to check or uncheck the check box. When the check box of the motion path information setting area 631 is unchecked, the animation is output with the motion path undisplayed, as illustrated in FIG. 12B. When the check box of the motion path information setting area 631 is checked, the animation is output with the motion path displayed, as illustrated in FIG. 12C.

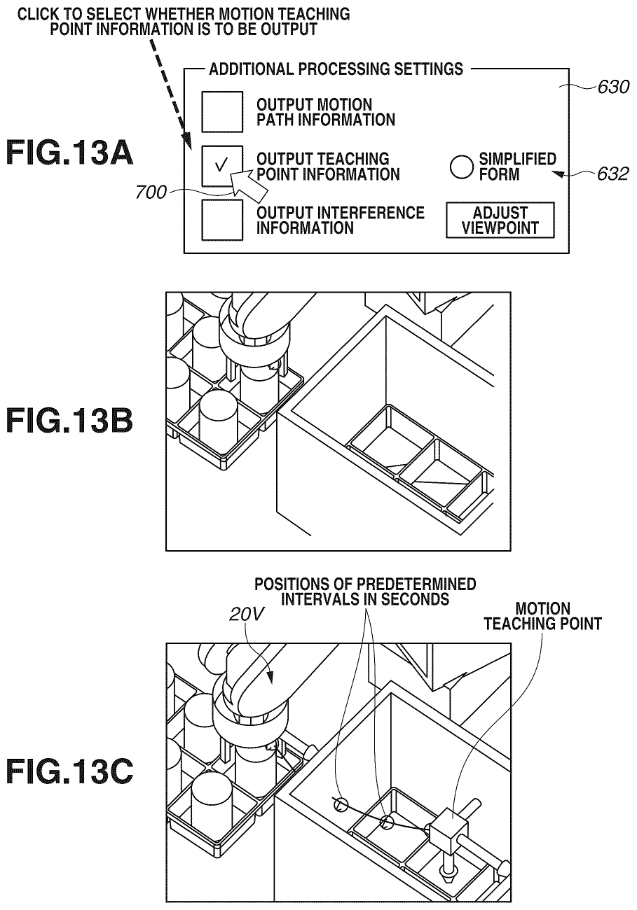

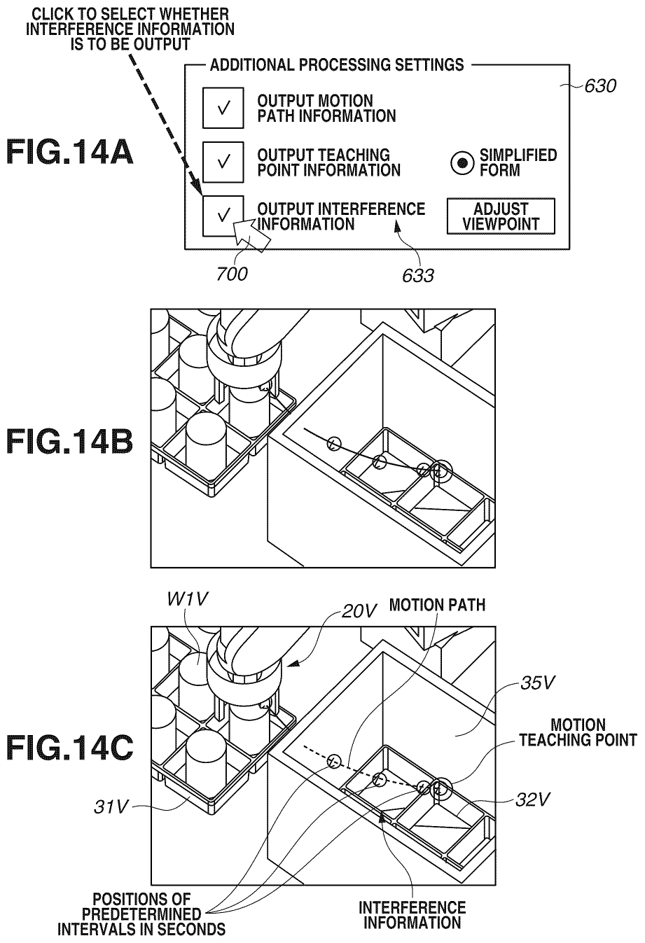

FIGS. 13A to 13C illustrate operations in the additional processing setting area 630 at the time of execution of step S1′-2 according to the present exemplary embodiment. In step S1′-2, the CPU 451 sets whether to output motion teaching point information in the animation when outputting simulation results as animation data. FIG. 12A illustrates the additional processing setting area 630 when information about the motion teaching point of the virtual robot hand 20V of the virtual robot body 30V is displayed in the animation data to be output via the additional processing setting area 630. FIG. 13B illustrates the animation with the motion teaching point undisplayed. FIG. 13C illustrates the animation with the motion teaching point displayed. Referring to FIG. 13C, the animation displays the positions of the virtual robot hand 20 at predetermined intervals in seconds in addition to the motion teaching point. Referring to FIG. 13C, the animation displays detailed motion teaching point indicated by directional arrows for different axes. To improve the visibility and reduce the amount of data, the motion teaching point can be displayed in a simplified form in the animation data to be output, as illustrated in FIG. 14C. The user sets whether to display the motion teaching point in a simplified form by using a simplified form check box in the teaching point information setting area 632.

Referring to FIG. 13A, the user clicks the check box of the teaching point information setting area 632 with the cursor 700 to check or uncheck the check box. When the check box of the teaching point information setting area 632 is unchecked, the animation is output with the motion teaching point undisplayed, as illustrated in FIG. 13B. In contrast, when the check box of the motion path information setting area 631 is checked, the animation is output with the motion teaching point displayed, as illustrated in FIG. 13C.

FIGS. 14A to 14C illustrate operations in the additional processing setting area 630 at the time of execution of step S1′-3 according to the present exemplary embodiment. In step S1′-3, the CPU 451 sets whether to output the interference information when outputting simulation results as animation data. FIG. 14A illustrates the additional processing setting area 630 when information about the interference between the virtual robot hand 20V of the virtual robot body 30V and surrounding objects is displayed in the animation data to be output via the additional processing setting area 630. FIG. 14B illustrates the animation with the interference information undisplayed. FIG. 14C illustrates the animation with the interference information displayed. Referring to FIGS. 14B and 14C, information about the motion path and the motion teaching point (and positions of predetermined intervals in seconds) is displayed. Referring to FIG. 14C, since the simplified form check box is checked, the motion teaching point is displayed in a simplified form (double-circled), and directional arrows for different axes are omitted.

Referring to FIG. 14A, the user clicks the check box of the interference information setting area 633 with the cursor 700 to check or uncheck the check box. When the check box of the interference information setting area 633 is unchecked, the animation is output with the interference information undisplayed, as illustrated in FIG. 14B. In contrast, when the check box of the interference information setting area 633 is checked, the animation is output with the interference information displayed, as illustrated in FIG. 14C. Referring to FIG. 14C, the motion path is displayed with a dotted line as an interference information display method (dotted-line display). Referring to the motion path displayed with a dotted line, the virtual robot hand 20V is interfering with a virtual tray 32V and the virtual wall 35V based on simulation results. Although, in FIG. 14C, the motion path is displayed with a dotted line, the motion teaching point in an interference state (and positions at predetermined intervals in seconds) can also be displayed with a dotted line. Although, in FIG. 14C, the motion path or the motion teaching point is displayed with a dotted line as the display format of the interference information, a technique for enabling blinking display, color display, perspective display, or highlight display as required is also applicable. Although, in FIGS. 14B and 14C, the interference between the virtual robot hand 20V and surrounding objects is displayed, the virtual robot hand 20V, and the interference between the virtual work W1V supported by the virtual robot hand 20V and the surrounding object can be displayed.

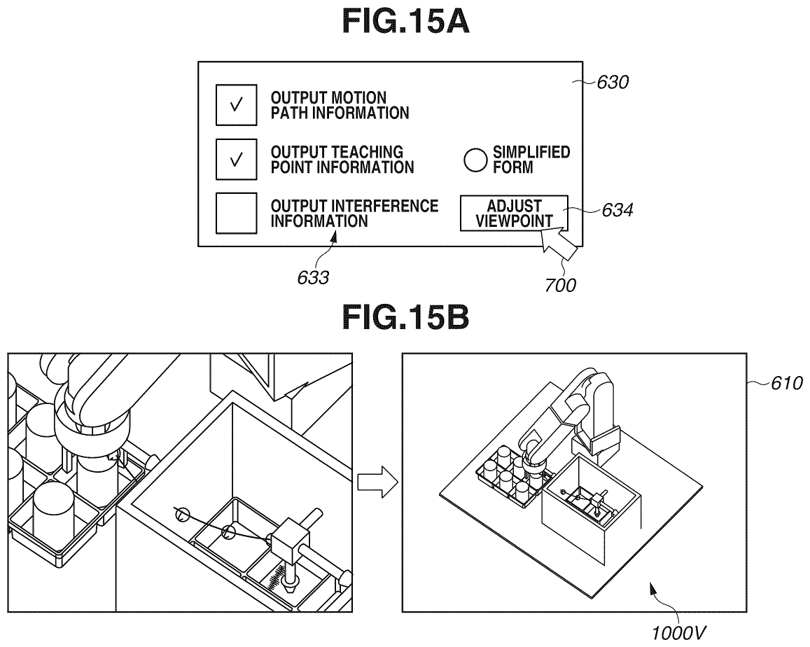

FIGS. 15A and 15B illustrate operations in the additional processing setting area 630 at the time of execution of step S1′-4 according to the present exemplary embodiment. In step S1′-4, the CPU 451 sets the viewpoint when outputting simulation results as animation data. FIG. 15A illustrates the additional processing setting area 630 when a viewpoint is set in the animation data to be output via the additional processing setting area 630. FIG. 15B illustrates a screen transition in the simulation result display area 610 upon depression of the viewpoint adjust button 634. When the user clicks the viewpoint adjust button 634 with the cursor 700, the user can adjust the display of the simulation by translating the viewpoint from the current one to display the entire image of the virtual robot system 1000V, thus adjusting the visual field.

In FIG. 15B, the user presses the viewpoint adjust button 634 to display the entire image of the virtual robot system 1000V. However, the present disclosure is not limited thereto. For example, if any motion path or motion teaching point is partly hidden according to the current viewpoint, the user can adjust the visual field by translating the viewpoint from the current one so that the partly hidden motion path or motion teaching point fits into the visual field.

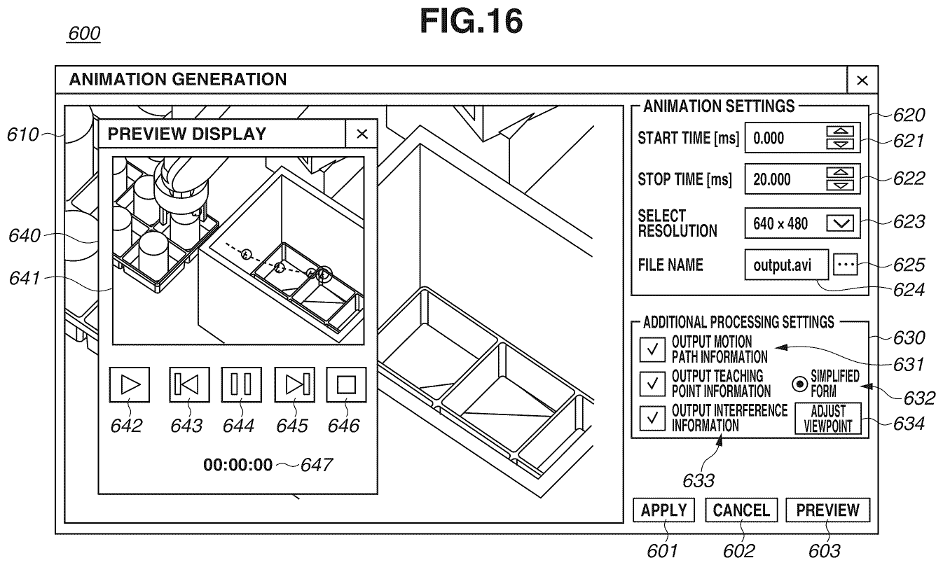

FIG. 16 illustrates the animation generation window 600 when the preview button 603 is pressed. When the user presses the preview button 603, the CPU 451 previews operations to be output based on the set information. When the user clicks the preview button 603, a preview display window 640 appears as a pop-up window. The preview display window 640 displays a preview screen 641 allowing the user to check the animation to be output.

The preview display window 640 also includes a playback button 642 for playing back the animation, a fast-reverse button 643 for fast-reversing the animation, a pause button 644 for pausing the animation, a fast-forward button 645 for fast-forwarding the animation, a stop button 646 for stopping the animation and resetting the display time to the start time, and a time display 647 for displaying the playback time of the animation. To close the preview display window 640, the user presses the close button at the upper right of the preview display window 640. These GUIs allow the user to easily check the animation to be output.

The animation output processing in step S2 will now be described. When the user clicks the apply button 601 in FIG. 16 with the cursor 700, the CPU 451 starts outputting (writing) simulation results to the recording disk 462 as animation data with various settings reflected thereto. After the user clicks the apply button 601, a pop-up menu can be displayed to check whether the user wants to start outputting (writing) simulation results. If the user wants to cancel the output (write) operation during execution of the output (writing) operation on the recording disk 462, the user clicks the cancel button 602.

As described above, the present exemplary embodiment enables outputting simulation results together with the information about operations of the virtual robot body 30 to the outside as animation data. This enables the user to share motion simulation results by the simulator 400 with another user not having a robot simulator in a visually comprehensible way. In particular, since the motion path and the motion teaching point can be displayed in the animation data, detailed operations can be displayed in a visually comprehensible way. Since the motion path and the motion teaching point can be displayed with the interference information, the CPU 451 can display and share the motion path or the motion teaching point where an interference occurs in operations of the robot body 30. The animation to be output can be previewed, allowing the user to easily check whether various settings of the animation have been correctly made.

A second exemplary embodiment will now be described in detail. In the above-described first exemplary embodiment, a user sets the start time or the stop time by inputting numerical values when outputting simulation results as animation data. According to the second exemplary embodiment, the user sets the start time or stop time by selecting the motion path or the motion teaching point in the simulation result display area 610. Hardware and control system components different from those according to the first exemplary embodiment will be described below with reference to the accompanying drawings. Elements similar to those according to the first exemplary embodiment are assumed to provide similar configurations and functions, and detailed descriptions thereof will be omitted.

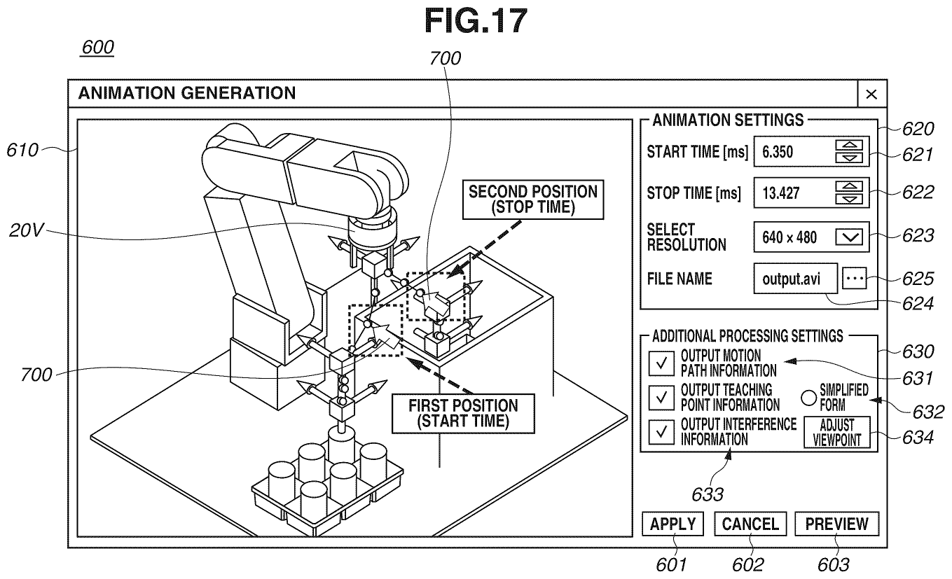

FIG. 17 illustrates the animation generation window 600 according to the present exemplary embodiment. As illustrated in FIG. 17, the user selects a first and a second positions with the cursor 700 from the motion path in the simulation result display area 610. When the user activates the start time setting area 621 with the cursor 700 and selects the first position in the motion path, the time when the virtual robot hand 20V is located at the first position is set to the start time setting area 621, assuming that the initial position of the motion path corresponds to 0 seconds. In the example illustrated in FIG. 17, a 6.350 seconds is set. Likewise, when the user activates the stop time setting area 622 with the cursor 700 and selects the second position in the motion path, the time when the virtual robot hand 20V is located at the second position is set to the stop time setting area 622, assuming that the initial position of the motion path corresponds to 0 seconds. In the example illustrated in FIG. 17, a 13.427 seconds is set. In the above descriptions, the user sets the start or the stop time by selecting a predetermined position of the motion path. However, the user can set the start or the stop time by selecting the motion teaching point.

According to the present exemplary embodiment, the user selects and sets the motion path or the motion teaching point displayed in the simulation result display area 610 when outputting simulation results as animation data. This setting method enables the user to more intuitively set an operation to be shared with another user than with the setting method by inputting numerical values, making it easy to set an animation range to be output.

A third exemplary embodiment will now be described in detail. The third exemplary embodiment automatically extracts and sets an operation recognized to be in a specific state (predetermined state) in simulation results. Hereinafter, hardware and control system components different from those according to the first exemplary embodiment will be described with reference to the accompanying drawings. Elements similar to those according to the first exemplary embodiment are assumed to provide similar configurations and functions, and detailed descriptions thereof will be omitted.

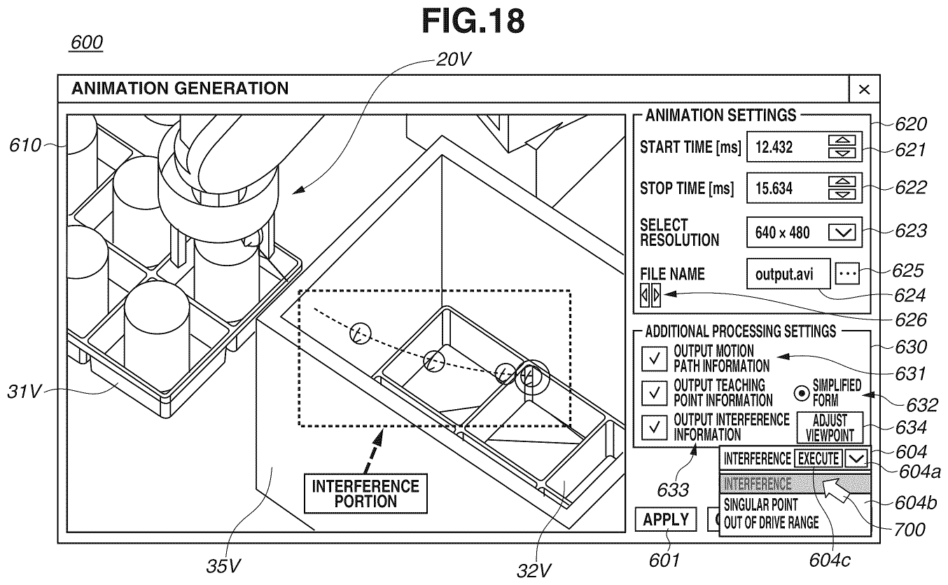

FIG. 18 illustrates the animation generation window 600 according to the present exemplary embodiment. Referring to FIG. 18, a specific state extraction area 604 is displayed according to the present exemplary embodiment. The specific state extraction area 604 has a pull-down button 604a. When the user clicks the pull-down button 604a with the cursor 700, a pull-down menu 604b indicating kinds of specific states appears. FIG. 18 illustrates Interference, Singular Point, and Out of Drive Range as specific states. However, the present disclosure is not limited thereto. When Interference is selected, the CPU 451 extracts a state where the virtual robot hand 20V is determined to be interfering with a surrounding object based on simulation results. When Singular Point is selected, the CPU 451 extracts a state where the virtual robot body 30 is determined to be a singular point based on simulation results. When Out of Drive Range is selected, the CPU 451 extracts a state where a mechanical mechanism, such as the motor, the reduction gear of the robot body 30, and the link, of the real machine is determined to be out of the operation range based on simulation results. These specific states are determined through simulation based on model data and mechanical element parameters in the robot system 1000 stored in the SSD 454.

Referring to FIG. 18 where Interference is selected, the CPU 451 extracts a state where the virtual robot hand 20V is determined to be interfering with a surrounding object, when the user clicks an Execute button 604c. Assuming that the initial position of the motion path corresponds to 0 seconds, the CPU 451 sets the start time (the time when an interference starts) to the start time setting area 621, and sets the stop time (the time when the interference stops) to the stop time setting area 622. Referring to FIG. 18, a 12.432 seconds is set to the start time setting area 621, and a 15.634 seconds is set to the stop time setting area 622.

When an interference state exists at a plurality of positions, clicking forward and reverse buttons 626 updates the animation output setting area 620 to a state where the start and the stop times of the following interference are set to the start time setting area 621 and the stop time setting area 622, respectively. For the forward and reverse buttons 626, the button on the left-hand side is a reverse button, and the button on the right-hand side is a forward button. Even if a plurality of specific states exists, the user can easily grasp a time zone where a specific state occurs. If a plurality of specific states exists, the CPU 451 generates and outputs animation data so that specific states are reproduced in succession. A singular point state and an out of drive range state are also extracted like the interference state.

According to the present exemplary embodiment, the CPU 451 extracts an operation in a specific state and outputs animation data when outputting simulation results as animation data. This makes it easier for the user to output an operation in a specific state to be shared in the operation to be shared with another user, and to efficiently validate operations of the robot body 30.

A fourth exemplary embodiment will now be described in detail. The fourth exemplary embodiment superimposes the motion path onto a different animation file (animation data). Hardware and control system components different from those according to the above-described different exemplary embodiments will be described with reference to the accompanying drawings. Elements similar to those according to the above-described different exemplary embodiments are assumed to provide similar configurations and functions, and detailed descriptions thereof will be omitted.

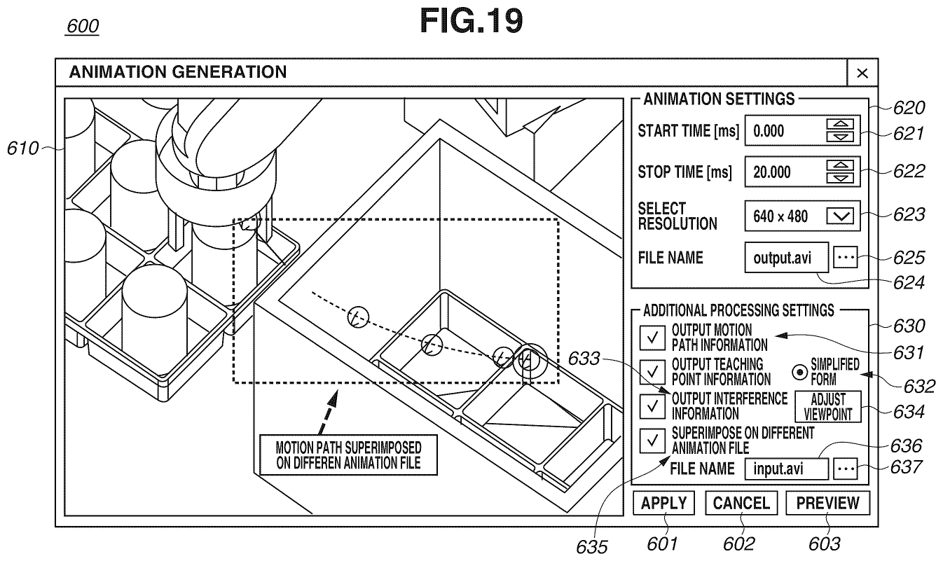

FIG. 19 illustrates the animation generation window 600 according to the present exemplary embodiment. Referring to FIG. 19, a superimposed display setting area 635 is displayed. The superimposed display setting area 635 includes an input file name setting area 636 and an input source setting button 637. When the user specifies an input file name in the input file name setting area 636 with the keyboard 403 and clicks on the input source setting button 637 with the cursor 700, a different animation file (animation data) as an input source is specified.

Referring to FIG. 19, a different animation file (input.avi) is input as an example, and the animation file (input.avi) is displayed in the simulation result display area 610. The CPU 451 extracts, or prompts the user to set, the model corresponding to the virtual robot hand 20V and the reference point for the model (Tool Center Point) in the different animation file (input.avi). The CPU 451 then superimposes the motion path on the different animation file (input.avi) with reference to the model corresponding to the virtual robot hand 20V and the reference point for the model, at the start time (0 seconds).

When the user presses the preview button 603 with the superimposed display setting area 635 checked, the different animation file (input.avi) is displayed in the simulation result display area 610 together with the motion path. Referring to the example in FIG. 19, the motion path information, the motion teaching point information, and the interference information are superimposed on the different animation file (input.avi) in a state where the output of the motion path information, the motion teaching point information, and the interference information is set. When the user presses the apply button 601 in this state, the different animation file (input.avi) can be output with the motion path superimposed.

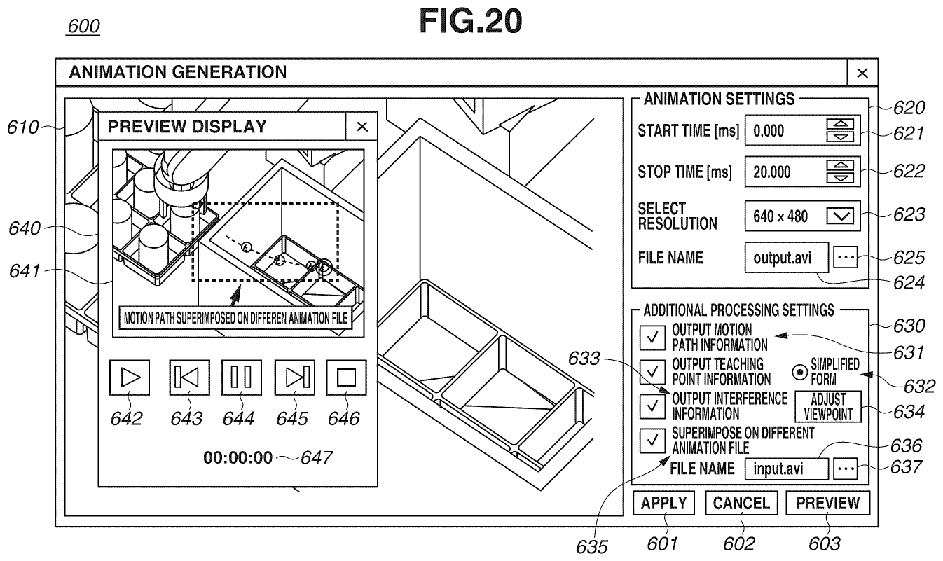

In FIG. 19, the different animation file (input.avi) is displayed in the simulation result display area 610. However, the present disclosure is not limited thereto. For example, the different animation file (input.avi) can be displayed in the preview screen 641 in the preview display window 640 as illustrated in FIG. 20. The different animation file (input.avi) can then be played back, stopped, and paused with the motion path superimposed, by using various buttons displayed in the preview display window 640.

As described above, the present exemplary embodiment enables superimposing information about operations of the robot body 30 on an animation file that simulates, for example, operations of a robot body different from the robot body 30. This makes it easier for the user to determine whether operation information set by the robot body 30 can be diverted to the different robot. This enables sharing information about operations of one robot between different animation files that simulate operations of different robots. This enables efficiently validating whether information about operations of one robot can be diverted to the different robot.

A fifth exemplary embodiment will now be described in detail. The fifth exemplary embodiment will be described centering on a case where the animation files output in the above-described different exemplary embodiments are displayed on a head-mounted display as an operation terminal worn by a user. Hardware and control system components different from those according to the above-described exemplary embodiments will be described below with reference to the accompanying drawings. Elements similar to those according to the above-described different exemplary embodiments are assumed to provide similar configurations and functions, and detailed descriptions thereof will be omitted.

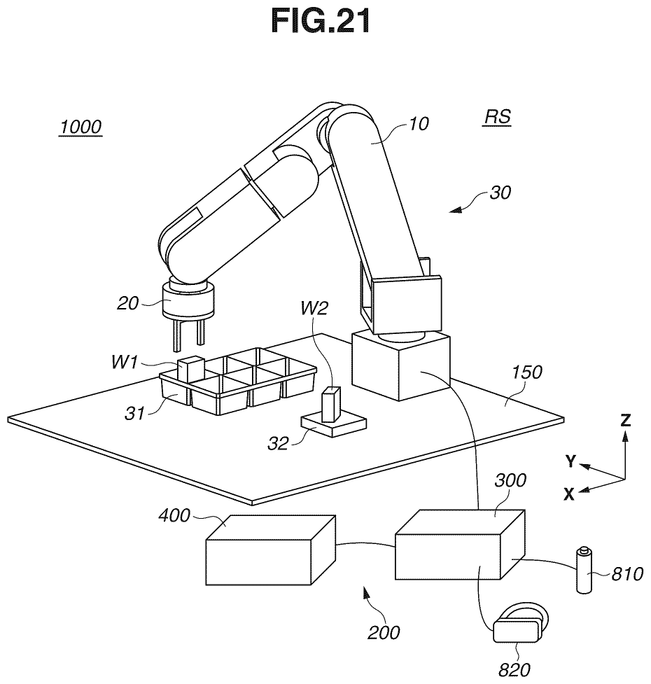

FIG. 21 illustrates the robot system 1000 according to the present exemplary embodiment. The robot controller 300 is connected with an operation unit 810 and a head-mounted display 820. According to the present exemplary embodiment, the operation unit 810, the head-mounted display 820, and the robot controller 300 may be collectively referred to as an information processing apparatus. The present exemplary embodiment will be described below centering on an example case where the operation unit 810 and the head-mounted display 820 are connected to the robot controller 300. However, the present disclosure is not limited thereto. For example, the operation unit 810 and the head-mounted display 820 can be connected to the simulator 400. Although the operation unit 810 and the head-mounted display 820 can be wiredly or wirelessly connected, wireless connection is preferable because these units are worn by the user.

The head-mounted display 820 displays an image of the robot system 1000 of the real machine through a user's viewpoint. The animation files output in the above-described different exemplary embodiments can be previewed. The head-mounted display 820 can be operated through cursor operations using the operation unit 810. According to the present exemplary embodiment, the user operates the screen of the head-mounted display 820 by using the operation unit 810. However, the user can perform touch operations if the head-mounted display 820 is of a touch panel type. Screens displayed on the head-mounted display 820 will be described in detail below.

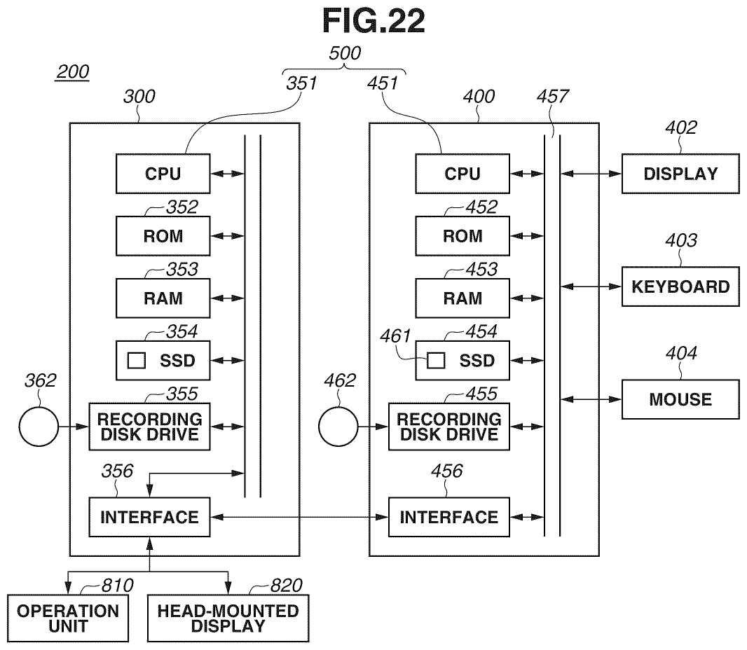

FIG. 22 is a control block diagram illustrating a control system according to the present exemplary embodiment. As illustrated in FIG. 22, the robot controller 300 according to the present exemplary embodiment communicates and connects with the operation unit 810 and the head-mounted display 820 via the interface 356. The animation file can thereby be displayed on the head-mounted display 820 via the interfaces 356 and 456. The interface 456 is used to connect the operation unit 810 and the head-mounted display 820 to the simulator 400.

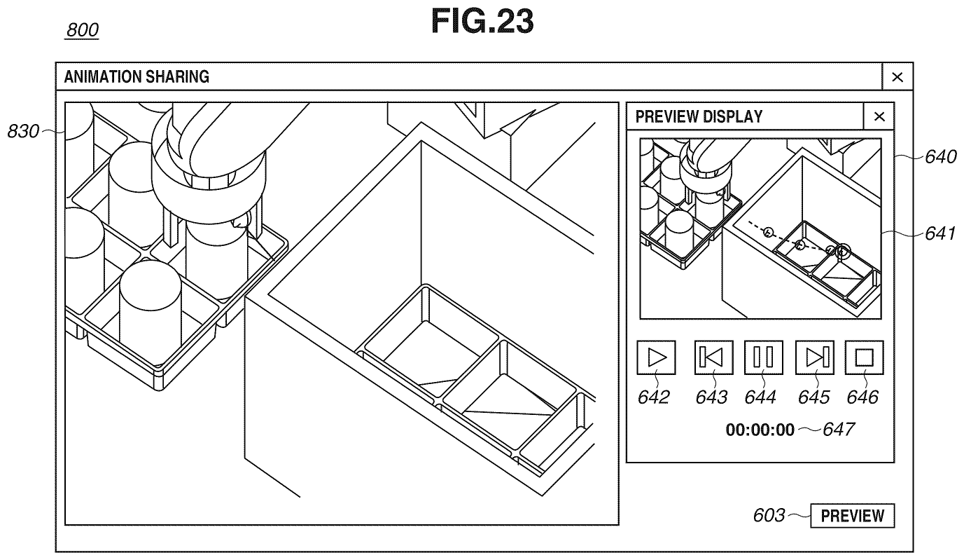

FIG. 23 illustrates an animation sharing screen 800 displayed on the head-mounted display 820 according to the present exemplary embodiment. Referring to FIG. 23, the animation sharing screen 800 displays a user viewpoint image 830 as an image through the user's viewpoint acquired (captured) by the camera installed on the head-mounted display 820. The animation sharing screen 800 displays the preview button 603. When the user presses the preview button 603 with the operation unit 810, the preview display window 640 appears. In a state where the preview display window 640 is displayed, pressing the preview button 603 undisplays the preview display window 640.

The preview screen 641 in the preview display window 640 displays the animation files output in the above-described different exemplary embodiments. The preview display window 640 also displays the playback button 642 for playing back the animation, the fast-reverse button 643 for fast-reversing the animation, the pause button 644 for pausing the animation, the fast-forward button 645 for fast-forwarding the animation, the stop button 646 for stopping the animation and resetting the display time to the start time, and the time display 647 for displaying the playback time of the animation. To close the preview display window 640, the user presses the close button at the upper right of the preview display window 640. These GUIs allow the user to easily check the animation to be output.

As described above, the present exemplary embodiment enables outputting the animation file with operation information superimposed thereon to the head-mounted display 920. This enables the user, for example, to simulate operations with the simulator 400 and output information about set operations of the robot body 30 to the head-mounted display 920 as an animation file. This allows the user operating the simulator 400 and the user wearing the head-mounted display 920 to easily share information about operations of the robot body 30. In an operation that the user intends to share with another user, the user can easily output information to be shared and efficiently validate operations of the robot body 30.

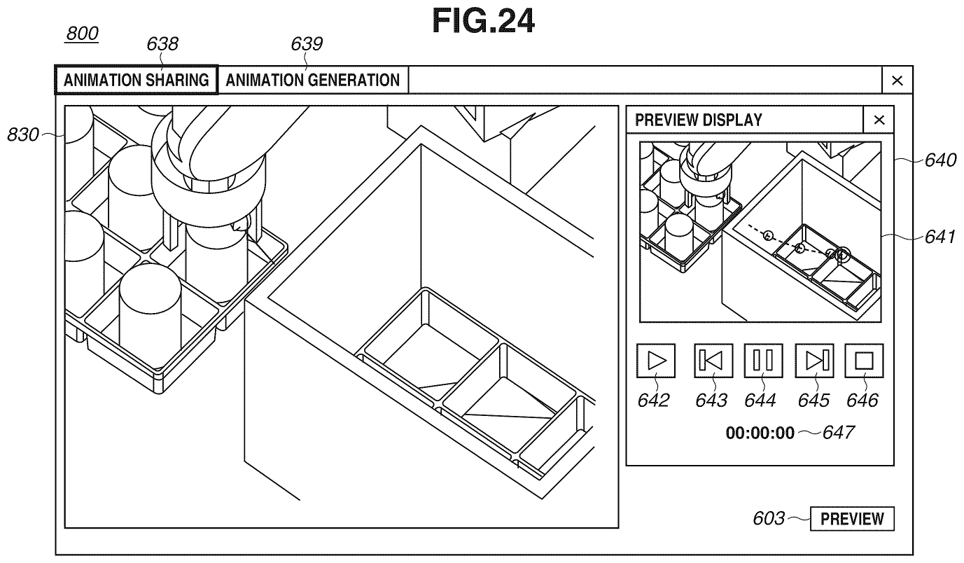

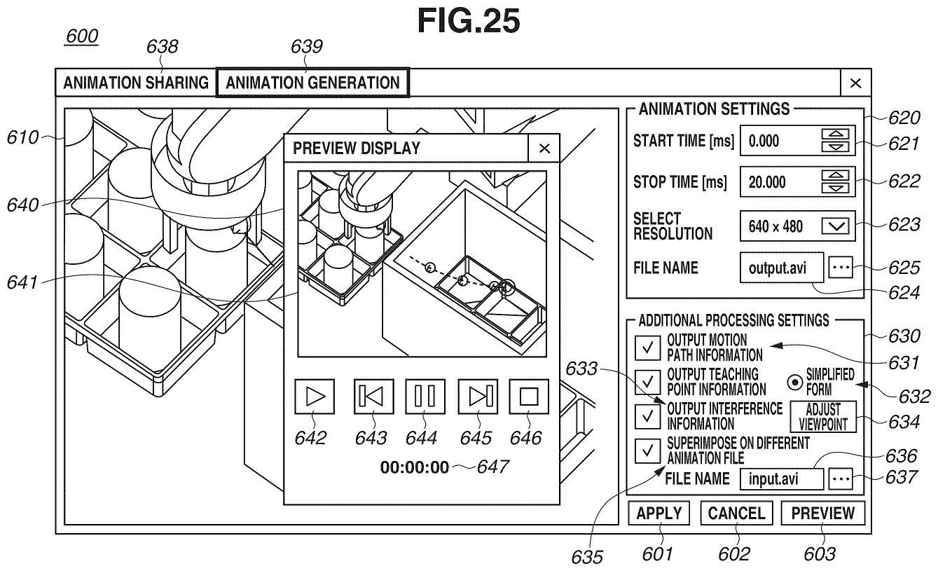

Although the present exemplary embodiment has been described above centering on an example case where the preview display window 640 is displayed on the head-mounted display 820, the present disclosure is not limited thereto. For example, settings for the motion path display according to the above-described different exemplary embodiments can be made from the head-mounted display 920. FIG. 24 illustrates a state where selecting a tab 638 displays the animation sharing screen 800 on the head-mounted display 820. FIG. 25 illustrates a state where selecting a tab 639 displays the animation generation window 600 on the head-mounted display 820. Although the preview display window 640 appears in the screens in FIGS. 24 and 25, the preview display window 640 can appear in either one screen.

The above-described configuration allows the user wearing the head-mounted display 820 not only to easily share information about operations of the robot body 30 but also to directly specify required information. This configuration also enables efficiently validating operations of the robot body 30.

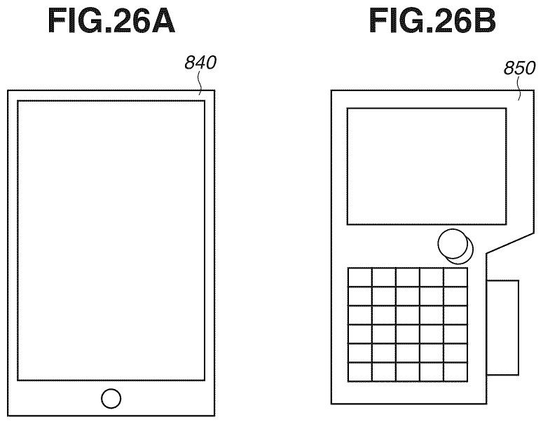

The present exemplary embodiment has been described above centering on an example case where a head-mounted display is used as an operation terminal. However, the present disclosure is not limited thereto. For example, a screen illustrated in FIG. 23, 24, or 25 can be displayed on the display unit of a tablet teaching pendant 840 illustrated in FIG. 26A. A screen illustrated in FIG. 23, 24, or 25 can also be displayed on a display unit of a teaching pendant 850 operated with a jog stick and buttons, as illustrated in FIG. 26B.

A sixth exemplary embodiment will now be described in detail. The exemplary embodiments have been described centering on an example case where animation data is output (written or displayed) to an operation terminal, such as the offline recording disk 462 or the head-mounted display 820. The sixth exemplary embodiment will be described below centering on an example case where the simulator 400 is connected to a network and animation data is shared online. Hardware and control system components different from those according to the first exemplary embodiment will be described below with reference to the accompanying drawings. Elements similar to those according to the first exemplary embodiment are assumed to provide similar configurations and functions, and detailed descriptions thereof will be omitted.

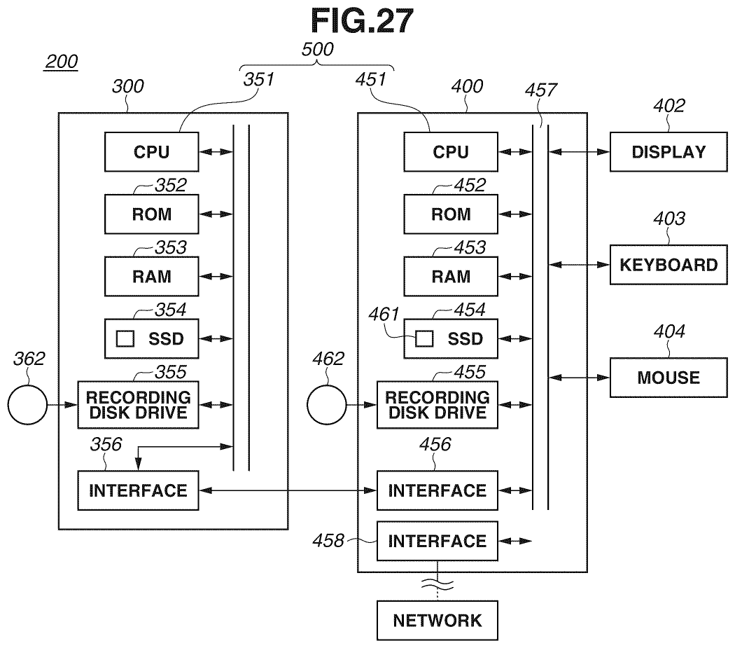

FIG. 27 is a block diagram illustrating the computer system 200 according to the present exemplary embodiment. Referring to FIG. 27, the simulator 400 according to the present exemplary embodiment includes an interface 458 for communicating and connecting with the network. The interface 458 conforms to general communication standards, such as Ethernet® and Wi-Fi®. Other applicable communication standards include Worldwide Interoperability for Microwave Access (WiMAX®). The simulator 400 enables online sharing of animation data with other users via the interface 458 and the network. Other applicable sharing methods include mail transmission, a Web conference tool, and a cloud system. Applicable sharing methods also include moving image sharing services, such as YouTube® that allow users to upload moving images. Another applicable sharing method is the use of a personal computer (PC) with another simulator installed thereon. This method can output animation data to the PC based on the moving image data format corresponding to the other simulator via a network, and share the animation data on the PC.

As described above, the present exemplary embodiment enables online sharing of animations by using a network, making it possible to efficiently validate operations of the robot body 30.

The processing performed by the simulator 400 according to the above-described different exemplary embodiments is specifically executed by the CPU 451. Thus, the CPU 451 can also read a software program for implementing the above-described functions from a recording medium recording the program, and then execute the program. In this case, the program itself read from the recording medium implements the functions of the above-described different exemplary embodiments. Embodiments of the present disclosure include the program itself and the recording medium recording the program.

In the above-described different exemplary embodiments, the program is stored in a computer-readable recording medium, such as a ROM, RAM, or flash ROM. However, the present disclosure is not limited to such a configuration. The program for implementing embodiments of the present disclosure can be recorded in a computer-readable recording medium of any type. Examples of applicable recording media for supplying control programs include a hard disk drive (HDD), external storage device, and recording disk.

In the above-described different exemplary embodiments, the robot arm 10 is an articulated robot arm having a plurality of joints. However, the number of joints is not limited thereto. In the above-described different exemplary embodiments, a vertical multi-axis configuration is used as the robot arm type. However, a configuration equivalent to the above-described one can be applied to joints of different types, such as a horizontal articulated type, parallel link type, and orthogonal robot type.

The above-described different exemplary embodiments are also applicable to machines capable of automatically performing expansion, contraction, bending, stretching, heave, sway, rotating, or a combination of these motions based on information in the storage device provided in the control apparatus.

The present disclosure is not limited to the above-described exemplary embodiments but can be modified in diverse ways without departing from the technical concepts of the present disclosure. Effects according to the above-described exemplary embodiments are to be considered as merely an enumeration of most preferable effects derived from embodiments of the present disclosure, and effects of embodiments of the present disclosure are not limited thereto. The above-described different exemplary embodiments and modifications can be implemented in a combination.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2022-086971, filed May 27, 2022, and No. 2023-050403, filed Mar. 27, 2023, which are hereby incorporated by reference herein in their entirety.

What is claimed is:

1. An information processing apparatus comprising:
one or more processors configured to cause the information processing apparatus to:
perform a simulation of operations of a robot in a virtual space; and
output positional information about the operations of the robot that has performed the simulation together with animation data of the operations of the robot that has performed the simulation.

2. The information processing apparatus according to claim 1, wherein the positional information includes at least one of a motion path or a motion teaching point in the operations of the robot.

3. The information processing apparatus according to claim 2, wherein the one or more processors are configured to cause the information processing apparatus to change a display format of the motion teaching point in outputting the positional information with the animation data from a display format of the motion teaching point in displaying results of the simulation.

4. The information processing apparatus according to claim 3, wherein the one or more processors are configured to cause the information processing apparatus to simplify the display format of the motion teaching point in outputting the positional information with the animation data more than the display format of the motion teaching point in displaying results of the simulation.

5. The information processing apparatus according to claim 2, wherein it is possible to set whether to output the motion path or the motion teaching point with the animation data.

6. The information processing apparatus according to claim 2, wherein it is possible to set whether to output the motion path or the motion teaching point with the animation data by differentiating a display format of at least one of the motion path or the motion teaching point in a state where the robot is interfering with a surrounding object from the display format of at least one of the motion path or the motion teaching point in a state where the robot is interfering with no surrounding object.

7. The information processing apparatus according to claim 6, wherein the display format of at least one of the motion path or the motion teaching point in a state where the robot is interfering with the surrounding object is at least one of dotted-line display, blinking display, color display, or perspective display.

8. The information processing apparatus according to claim 1, wherein the one or more processors are configured to cause the information processing apparatus to set a viewpoint in the animation data.

9. The information processing apparatus according to claim 8, wherein the one or more processors are configured to cause the information processing apparatus to provide a button for automatically adjusting the viewpoint to a viewpoint for viewing an entire image of the robot or to a viewpoint for viewing the robot in a non-hidden state in a case where a motion path or a motion teaching point in the operations of the robot is partly hidden.

10. The information processing apparatus according to claim 1, wherein the one or more processors are configured to cause the information processing apparatus to set a start time and a stop time of the animation data.

11. The information processing apparatus according to claim 10, wherein, by selecting a first position and a second position related to the operations of the robot in a display unit displaying results of the simulation, the one or more processors are configured to cause the information processing apparatus to set a time when a predetermined portion of the robot is located at the first position as the start time, and a time when the predetermined portion is located at the second position as the stop time.

12. The information processing apparatus according to claim 10, wherein, based on the simulation, a time when the robot started a predetermined state is set as the start time, and a time when the robot stopped the predetermined state is set as the stop time.

13. The information processing apparatus according to claim 12, wherein the predetermined state includes at least one of a state where the robot is interfering with a surrounding object, a state where the robot is a singular point, and a state where a mechanical mechanism of the robot is out of an operation range.

14. The information processing apparatus according to claim 13, wherein the one or more processors are configured to cause the information processing apparatus to select the predetermined state from a pull-down menu.

15. The information processing apparatus according to claim 12, wherein, in a case where there is a plurality of the predetermined states, the animation data is acquired so that the predetermined states are reproduced in succession.

16. The information processing apparatus according to claim 15, wherein the one or more processors are configured to cause the information processing apparatus to confirm a time when each of the plurality of the predetermined states is started and a time when each of the plurality of the predetermined states is stopped.

17. The information processing apparatus according to claim 1, wherein the one or more processors are configured to cause the information processing apparatus to set a resolution of the animation data.

18. The information processing apparatus according to claim 1, wherein the one or more processors are configured to cause the information processing apparatus to set a name of the animation data.

19. The information processing apparatus according to claim 1, wherein the one or more processors are configured to cause the information processing apparatus to preview the animation data.

20. The information processing apparatus according to claim 19,
wherein the animation data is previewed as a pop-up window, and
wherein the pop-up window displays a preview screen for previewing the animation data, a playback button for playing back the animation data, a pause button for pausing the animation data, a stop button for stopping the animation data, a fast-forward button for fast-forwarding the animation data, a fast-reverse button for fast-reversing the animation data, and a time display for displaying a playback time of the animation data.

21. The information processing apparatus according to claim 1,
wherein the information processing apparatus is connected to a network, and
wherein the one or more processors are configured to cause the information processing apparatus to upload the animation data to a moving image sharing service via the network.

22. The information processing apparatus according to claim 1, wherein the animation data is independent of data for displaying the virtual space in the simulation.

23. The information processing apparatus according to claim 1, wherein the one or more processors are configured to cause the information processing apparatus to output the positional information to be output with the animation data to animation data having a format different from a format of the animation data.

24. The information processing apparatus according to claim 1, wherein the one or more processors are configured to cause the information processing apparatus to output the animation data to an operation terminal operated by a user.

25. The information processing apparatus according to claim 24, wherein the one or more processors are configured to cause the information processing apparatus to make settings regarding display of the positional information to be output with the animation data with the operation terminal.

26. The information processing apparatus according to claim 24, wherein the operation terminal is a head-mounted display or a teaching pendant.

27. A robot system comprising a robot of which operations are set by the information processing apparatus according to claim 1.

28. An article manufacturing method for manufacturing an article by using the robot system according to claim 27.

29. An information processing method comprising:
performing a simulation of operations of a robot in a virtual space; and
outputting positional information about the operations of the robot that has performed the simulation together with animation data of the operations of the robot that has performed the simulation.

30. A non-transitory computer-readable recording medium storing a program for executing the information processing method according to claim 29.
